(19) United States
(12) Patent Application Publication
(10) Pub. No.: US 2006/0138129 A1
(43) Pub. Date: Jun. 29, 2006

(54) Microwave oven accessory

(75) Inventor: Peter Marshall, Oxfordshire (GB)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: MICROWISE COOKWARE LIMITED.

(21) Appl. No.: 11/187,684

(22) Filed: Jul. 22, 2005

(30) Foreign Application Priority Data
Dec. 29, 2004 (GB) 0428430.3

(51) Int. Cl. H05B 6/80

(52) U.S. Cl. 219/732

(57) ABSTRACT

A microwave oven accessory for removing packaged food after heating in a microwave oven comprising a base member, that in use is placed under the packaged food; a handle and; a grip member, the grip member having teeth or barbs; and means of moving the grip member from a position in which it is free of the package to a position where the teeth or barbs grip the package and thereby facilitates safe serving of the heated food from the microwave; this being achieved by pivotally mounting the grip member within the handle.

### BACKGROUND OF INVENTION

This invention relates to a microwave oven accessory to facilitate insertion, removal and subsequent serving of hot food from a microwave oven after cooking, and in particular for such use with pre-packaged food items.

Microwave ovens are often used to reheat or cook food packaged in plastic trays typically sealed by an upper plastic film. Typically, consumers place such packaged food in a microwave oven by hand. However, after heating or cooking of the packaged food, removal from the microwave oven can be hazardous; not only because the food is often very hot but also because the tray containing the food becomes far less rigid, particularly in the case of food contained in plastic trays. There is therefore a need to provide kitchen equipment to assist consumers in safely removing such food from microwave ovens.

### BRIEF SUMMARY OF INVENTION

It is an object of the present invention to provide a microwave oven accessory that facilitates safe and convenient removal and subsequent serving of hot food from a microwave oven.

In one aspect the invention relates to a microwave oven accessory for removing packaged food after heating in a microwave oven comprising a base member placed under the packaged food; and a separate grip member wherein in use the grip member may be moved from a first position in which it is free of the package to a second position where it grips the package and thereby facilitates safe serving of the heated food from the microwave.

The grip member may comprise a tooth, blade, a barb or the like. This facilitates puncturing of a plastic upper film of a food container. The grip member may be pivotably mounted either directly or indirectly to the base member. The grip member may comprise a pivotally mounted main body portion and intermediate portion. The grip member may be detachable from rest of the accessory. Preferably, at least one handle member is connected directly or indirectly to base member the grip member and the handle member may be the same member. Preferably, the grip member is pivotably mounted in the handle member. The handle member may have a generally rectangular shaped orifice within which the grip member is pivotally mounted. Resilient means may bias the grip remains in either the first or second position when not in use. Such resilient means may comprise a plastic spring that provides a force between a handle, connected directly or indirectly to the base member, and a pivotable grip member.

### DESCRIPTION OF DRAWINGS

The invention will now be described by reference to the following diagrammatic figures in which:

FIG. 1 shows a perspective view of a microwave oven accessory according to a first embodiment of the invention;

FIG. 2 shows a perspective view of part of the grip portion of the accessory of FIG. 1;

FIGS. 3a and 3b show topside perspective views of the accessory of FIG. 1 with and without the grip portion;

FIG. 4 shows an underside perspective view respectively of the accessory of FIG. 1 without the grip portion

FIGS. 5(a) to 5(d) show how the grip of the accessory of FIG. 1 engages a food package prior to cooking or preheating;

FIG. 6 shows a perspective view of a microwave oven accessory according to a second embodiment of the invention;

FIGS. 7 and 8 show a side view and a plan view respectively of a microwave oven accessory according to a third embodiment of the invention;

FIG. 9 shows a perspective view of a microwave oven accessory according to a fourth embodiment of the invention; and

FIG. 10 shows a perspective view of the grip member of the accessory of FIG. 9.

### DETAILED DESCRIPTION OF INVENTION

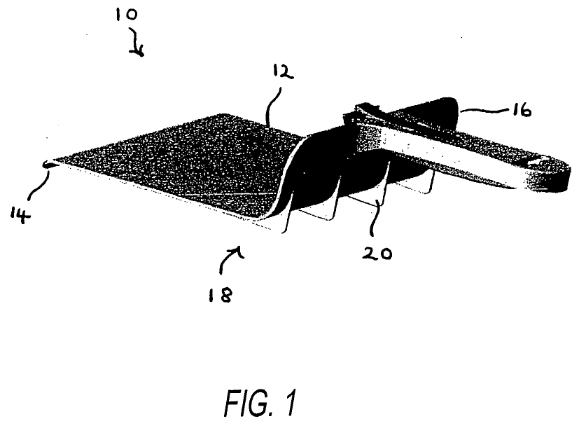

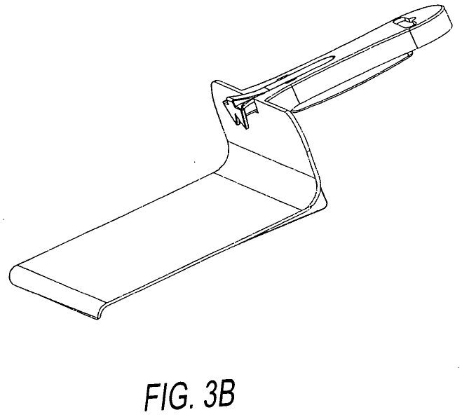

FIGS. 1 to 4 illustrate a first embodiment of the invention. The microwave oven accessory 10 comprises a substantially flat and rectangular shaped base member 12 with a curved front lip 14; the rear of the base member extending to an integrally formed end wall 16; the combination of the base member 12 and the end wall 16 forming a scoop 18 that has a generally “L-shaped cross section. Scoop 18 is reinforced by four integrally formed “L-shaped” ribs 20 located on the underside of the base member and the outer face of the lower curved portion of upward facing member 16. That part of each rib 20 formed on the underside of base member 12 is tapered in longitudinally; in use, this together with curved front lip 14 assists locating the scoop portion 18 under a food package. These features also result in the scoop being raised above the base of the microwave oven and this assists all round microwave penetration.

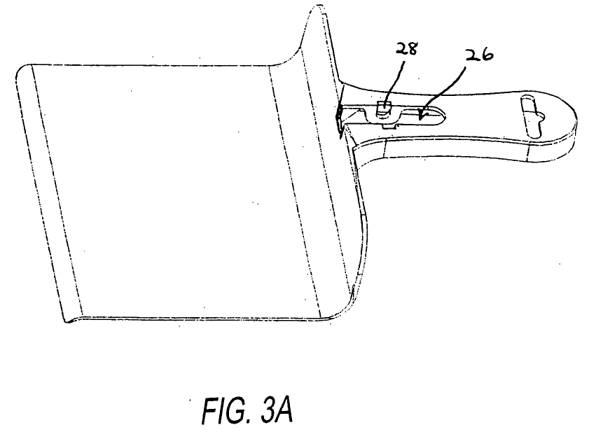

An integrally formed handle 22 is connected to the rear side of end wall 16, and is positioned centrally near the top of the end wall. The handle has an aperture 24 at end distant from wall 16, to allow the accessory to be stored on a hanger and also to be readily displayed at the point of sale. A generally rectangular shaped aperture 26, with a semi-circular end portion, is formed in that part of the handle nearest the end wall 16. This aperture also extends part way down wall 16. Both of the side walls of the handle aperture 26 have an integrally formed pivot rod housing 28 (see FIG. 3a).

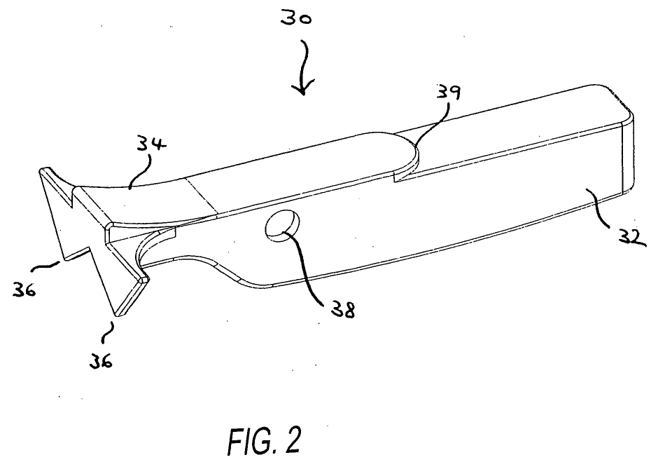

FIG. 2 shows grip member 30; this comprises a main portion 32 that has a generally “U-shaped” cross section and includes two side walls. Grip member 30 further comprises an upwardly projecting intermediate portion 34 with downwardly depending barbs, spades or teeth 36. Typically 2 or 3 barbs or teeth are provided. The main portion 32 has integrally formed co-axial shafts 38; each outwardly facing, each extending from a side wall of the main portion 32, which together form a pivot rod that allows the grip member to pivot within pivot rod housing 28 of handle 22. Shafts 38 have a circular cross section; however, the end faces are not perpendicular to the axis of the shafts and so have an eliptical shape which assists a press-fit locking engagement of the shafts 38 in pivot rod housing 28. Thus, grip member 30 may be pivoted from a first position where it is free of a food package held on the scoop to a second position where it grips the food package, teeth 36 preferably puncturing the top sealing film of the food package. This ensures that the food package is firmly held to the scoop portion 18 of the accessory 10. The upper face of main portion 32 comprises two flat surfaces at slightly different levels joined curved transition edge 39. Edge 39 is configured so that in use it fits tightly into the correspondingly curved end portion of aperture 26, and thereby keeps the grip in place in the handle member. Optionally, a resilient member, such as a spring made of plastics material, biases grip member 30 towards the second said position.

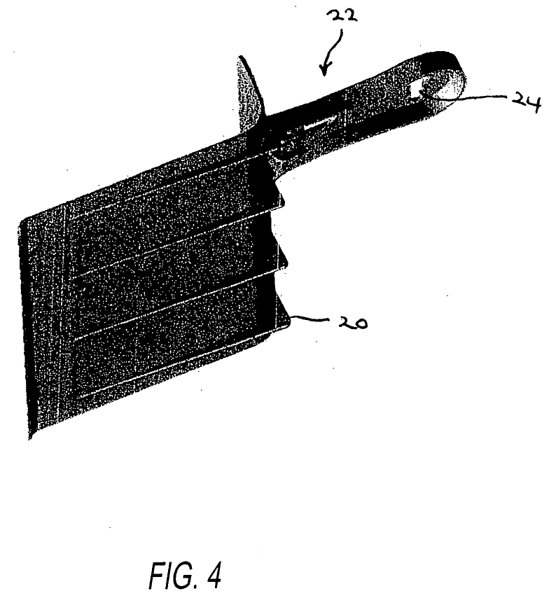

FIGS. 5.1 to 5.4 show the sequence of steps that occur during use of the accessory. FIG. 5.1 shows an empty accessory with the grip member in its normal (second) position. In order to engage and lift a food package P, a user pivots the grip member 30 to the second position (see FIG. 5.2) in which the teeth 36 are raised up and clear of the food package; the food package is then scooped up by the accessory (see FIG. 5.3); finally the grip portion is pivoted back to its rest (second) position and teeth 36 puncture the upper skin of the food package and so safely secure it to the scoop portion 18. When a resilient member is used (see above) this last action can be achieved merely by the user letting go of the grip member which under the influence of the biasing means then moves from the position shown in FIG. 5.3 to that shown in FIG. 5.4. Detachment of the food package from the accessory is achieved simply by reversing the order of the above steps.

The accessory may be used just to remove a food package that has been heated in a microwave oven. Alternatively an unheated food package may be placed in the microwave oven using this accessory and both the food package and accessory left in the oven during the heating cycle. The accessory may also left in the oven after heating with the cooked food resting upon it. The accessory will normally be made of a material such as plastics that does not appreciably absorb microwaves. Hence upon completion of the heating cycle the accessory handle will still be cool and a user will be able to use it to remove and optionally to serve the cooked food in a safer manner than normally possible.

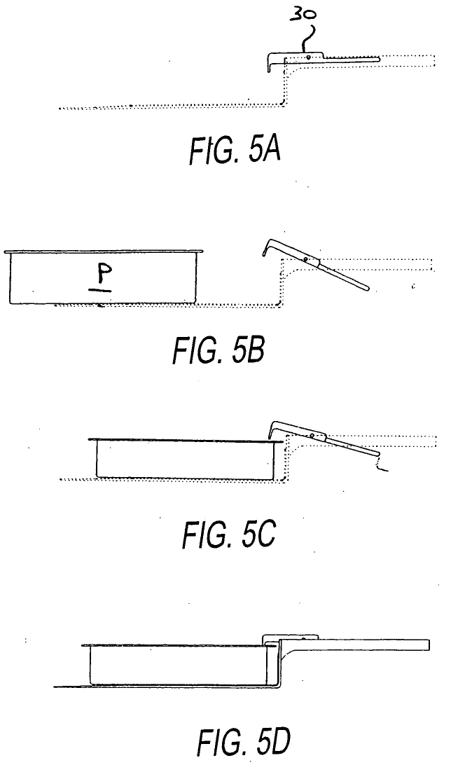

FIG. 6 shows a second embodiment of the invention. This comprises a scoop portion and handle portion as described above for the first embodiment, except that there is not a pivoting grip member mounted in the handle. Instead this embodiment uses two grip members 40 that in use serve a similar function to the teeth 36 of the first embodiment. Thus, a user scoops a food package as described above and then secures the unheated package to the rear wall of the accessory using grip members 40. Each grip member comprises a barbed first portion 42 that in use engages the food package, normally by puncturing the upper skin of the food package; a second abutment portion 44 that abuts the outer face of the rear wall of the scoop; and a third grip portion 46 provided for holding by a user during insertion (before heating) and removal (after heating) of the grip members 40.

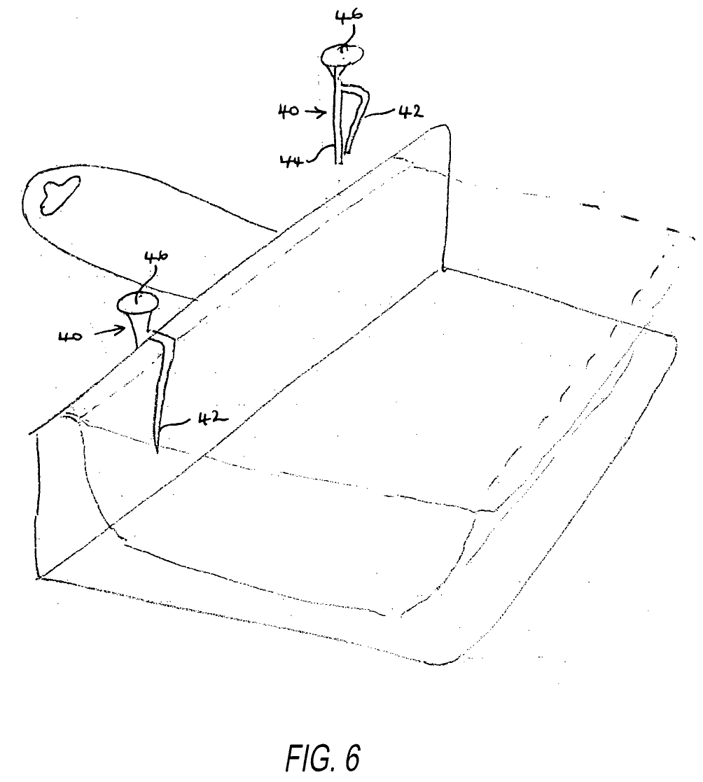

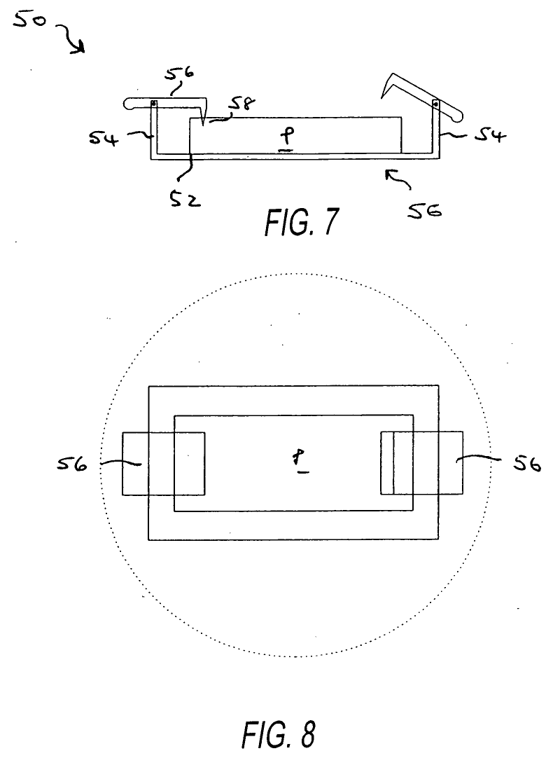

FIGS. 7 and 8 show a third embodiment of the invention in which the accessory 50 comprises a base portion 52, a pair of end walls 54 configured to form a generally “U-shaped” scoop portion 56. Each end wall 54 has a pivotally mounted grip member 56 with a blade or tooth 58 that in use may engage the food package in a similar way to that described for the first embodiment. Pivoting grip members 56 also serve as short handles to allow a user to pick up the accessory and food package using two hands. (see particularly FIG. 8). This embodiment is well suited for heating relatively large food packages where the space occupied within the oven by the accessory is advantageously minimised.

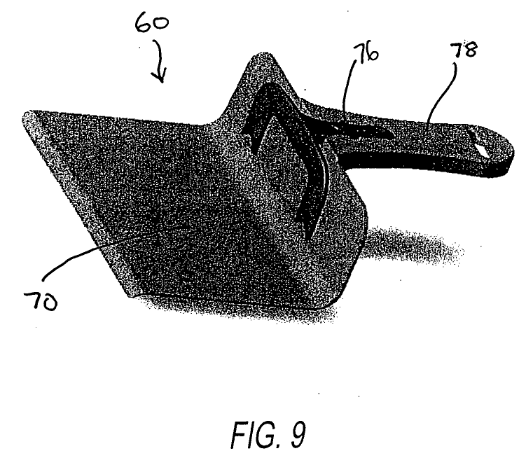

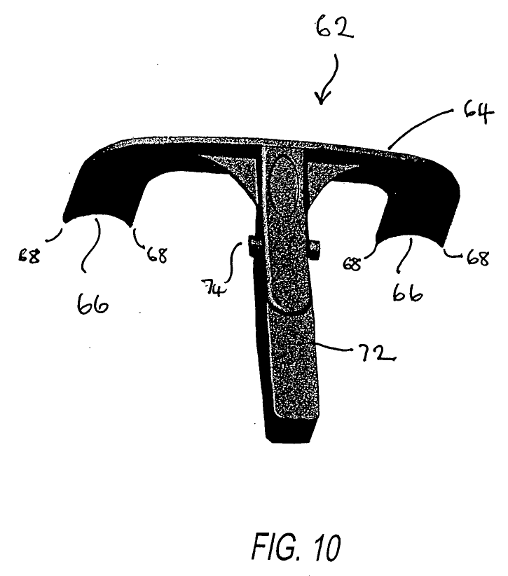

FIGS. 9 and 10 show a fourth embodiment of the invention 60, similar to the first embodiment described above, but having a different grip member 62. Grip member 62 comprises a generally U-shaped member 64; each arm of the U-shaped member 64 being relatively wide in comparison to its depth. Each arm of U-shaped member 64 has an inwardly curving arcuate portion 66 positioned width wise at each open end. Arcuate portions 66 present a pair of sharp corners 68 (teeth) at each open end of U-shaped member 64, in use teeth 68 are used to grip the upper surface of packaged food held on base member 70 of the accessory. Grip member 62 has a main portion 72 that is pivotally mounted 74 in a similar way to the first embodiment described above. In use the grip member is moved from a disengaged to an engaged position by pressing main portion 72 so that the grip member pivots about shafts 74 that locate in recesses 76 in the handle portion 78 of the accessory. Optionally, the first embodiment of the invention may use this similar pivot arrangement.

All of the above embodiments have a grip member that is not an integral part of the scoop. Each embodiment also has a barb, a blade, a tooth or the like that in use moves with the grip member to secure a food package. The barb, blade, tooth or the like may move by a pivoting action or may move in a generally vertical direction by non-pivoting means.

We claim:

1. A microwave oven accessory for removing packaged food after heating in a microwave oven comprising a base member that is in use placed under the packaged food; and a separate grip member wherein in use the grip member may be moved from a first position in which it is free of the packaged food to a second position where it grips the packaged food and thereby facilitates safe serving of heated food from the microwave.

2. A microwave oven accessory according to claim 1 wherein the grip member comprises at least one tooth, blade, a barb or the like.

3. A microwave oven accessory according to claim 1 wherein the grip member comprises a generally U-shaped member having a tooth, blade, barb or the like located at each end of the said U-shaped member.

4. A microwave oven accessory according to claim 1 wherein the grip member is pivotably mounted either directly or indirectly to the base member.

5. A microwave oven accessory according to claim 4 wherein the grip member comprises a pivotally mounted main body portion and intermediate portion.

6. A microwave oven accessory according to claim 1 wherein the grip member is detachable from rest of the accessory.

7. A microwave oven accessory according to claim 1 wherein at least one handle member is connected directly or indirectly to base member.

8. A microwave oven accessory according to claim 7 wherein the grip member and the handle member are the same member.

9. A microwave oven accessory according to claim 7 wherein the grip member is pivotably mounted in the handle member.

10. A microwave oven accessory according to claim 9 wherein the handle member has an aperture within which the grip member is pivotally mounted.

11. A microwave oven accessory according to claim 9 wherein the grip member has a transition edge that in use may resiliently engage a correspondingly shaped portion of the handle aperture.

12. A microwave oven accessory according to claim 1 comprising resilient means that bias the grip remains in either the first or second position when not in use.

13. A microwave oven accessory according to claim 12 wherein the resilient means is a plastic spring provides a force between a handle, connected directly or indirectly to the base member, and a pivotable grip member.
